(19) United States
(12) Patent Application Publication
(10) Pub. No.: US 2025/0356302 A1
(43) Pub. Date: Nov. 20, 2025

(54) BUSINESS SUPPORT APPARATUS, METHOD FOR PRODUCING GRAPH OF BUSINESS PROFITS, AND PROGRAM

(71) Applicant: ProfinanSS Inc., Tokyo (JP)

(72) Inventors: Yoshihiro KIMURA, Tokyo (JP); Ryotaro MORIKATSU, Tokyo (JP)

(21) Appl. No.: 19/211,588

(22) Filed: May 19, 2025

(30) Foreign Application Priority Data
May 20, 2024 (JP) 2024-081724

(51) Int. Cl. G06Q 10/067

(52) U.S. Cl. CPC G06Q 10/067

(57) ABSTRACT

A business support apparatus includes: a graph configuring unit that uses business information containing funnel information, tier information associated with the funnel information, and revenue information associated with the tier information, and further containing probability information of a next action being performed, to configure a graph with a graph structure in which the funnel information, the tier information, and the revenue information are taken as nodes, association between the funnel information and the tier information is taken as an edge connecting the node of the funnel information and the node of the tier information and association between the tier information and the revenue information is taken as an edge connecting the node of the tier information and the node of the revenue information. The nodes are respectively associated with names and the edges are associated with the probability information. A graph output unit outputs the graph.

### RELATED APPLICATION

This application claims priority to Japanese Patent Application No. 2024-081724 filed on May 20, 2024, the entire disclosure of which is incorporated herein by reference.

### BACKGROUND

### 1. Technical Field

The present invention relates to a business support apparatus and the like for visualizing a business profit structure.

### 2. Description of Related Art

Conventionally, there have been management support apparatuses that are aimed to break away from empirical rules and efficiently propose effective measures for improving management at business entities (see JP 2020-160633A, for example).

JP 2020-160633A is an example of related art.

However, it has not been possible for conventional techniques to properly visualize the business profit structure.

### SUMMARY

A first aspect of present invention is directed to a business support apparatus, including a business management unit in which business information on business corresponding to one budget is stored, the business information containing one or more pieces of funnel information that are each information on a funnel, which is a starting stage among one or two or more stages related to the business, and that each have a funnel name, one or more pieces of tier information that are associated with the one or more pieces of funnel information, that are each information for specifying a tier, which is a stage subsequent to a funnel and prior to a sale, and that each have a tier name, and one or more pieces of revenue information that are associated with the one or more pieces of tier information, that are each information for specifying a revenue, which is a commercial item or a category of commercial items subsequent to a tier, and that each have a revenue name, and further containing first probability information regarding funnel information and tier information that are associated with each other, which is information on a probability that a funnel specified with the funnel information is performed and a tier specified with the tier information is performed, and second probability information regarding tier information and revenue information that are associated with each other, which is information on a probability that a tier specified with the tier information is performed and a revenue specified with the revenue information is performed; a graph configuring unit that configures a graph with a graph structure in which the one or more pieces of funnel information, the one or more pieces of tier information, and the one or more pieces of revenue information are taken as nodes, association between the funnel information and the tier information is taken as an edge connecting the node of the funnel information and the node of the tier information, and association between the tier information and the revenue information is taken as an edge connecting the node of the tier information and the node of the revenue information, and in which the node of the funnel information, the node of the tier information, and the node of the revenue information are respectively associated with a funnel name, a tier name, and a revenue name, and the edges are associated with the first probability information or the second probability information; and a graph output unit that outputs the graph configured by the graph configuring unit.

With this configuration, it is possible to properly visualize the business profit structure by means of a graph.

Furthermore, a second aspect of the present invention is directed to the business support apparatus according to the first aspect, wherein the funnel information further contains a quantity of occurrences of an action corresponding to the funnel information, the tier information further contains a quantity of occurrences of an action corresponding to the tier information, the revenue information further contains a quantity of occurrences of an action corresponding to the revenue information, the graph configuring unit configures the graph in which the node of the funnel information, the node of the tier information, and the node of the revenue information are respectively associated with the funnel name and the quantity, the tier name and the quantity, and the revenue name and the quantity.

With this configuration, it is possible to properly visualize the business profit structure by means of a graph.

Furthermore, a third aspect of the present invention is directed to the business support apparatus according to the second aspect, wherein each of the one or more edges is associated with a lead time.

With this configuration, it is possible to properly visualize the business profit structure by means of a graph.

Furthermore, a fourth aspect of the present invention is directed to the business support apparatus according to the third aspect, further including: a sales information acquiring unit that acquires sales information for each of two or more months, using the quantity corresponding to each of the one or two or more revenues and the lead time; and a sales information output unit that outputs the sales information for each month acquired by the sales information acquiring unit.

With this configuration, it is possible to acquire sales information taking a lead time into account.

Furthermore, a fifth aspect of the present invention is directed to the business support apparatus according to any one of the first to fourth aspects, wherein the graph configuring unit configures the graph in which nodes of any type among the funnel information, the tier information, and the revenue information have an outline that is different depending on the type of node.

With this configuration, it is possible to properly visualize the business profit structure by means of a graph.

Furthermore, a sixth aspect of the present invention is directed to the business support apparatus according to the second aspect, wherein the one or more pieces of revenue information each have a unit price, and the graph configuring unit configures the graph in which a sales amount obtained by multiplying the unit price and the quantity is associated with each node of the one or more pieces of revenue information.

With this configuration, it is possible to properly visualize the business profit structure by means of a graph.

Furthermore, a seventh aspect of the present invention is directed to the business support apparatus according to any one of the first to sixth aspects, further including: an editing instruction accepting unit that accepts an editing instruction for the graph output by the graph output unit; a graph changing unit that changes the graph output by the graph output unit in response to the editing instruction; and a business information changing unit that changes the business information in the business management unit in response to the change made by the graph changing unit.

With this configuration, it is possible to edit a graph showing the business profit structure.

With the business support apparatus according to the present invention, it is possible to properly visualize the business profit structure.

### BRIEF DESCRIPTION OF THE DRAWINGS

FIG. 1 is a conceptual diagram of a business support system A in Embodiment 1.

FIG. 2 is a block diagram of the business support system A in the embodiment.

FIG. 3 is a flowchart illustrating an operation example of a business support apparatus 1 in the embodiment.

FIG. 4 is a flowchart illustrating an example of accumulating processing in the embodiment.

FIG. 5 is a flowchart illustrating an example of graph configurating processing in the embodiment.

FIG. 6 is a flowchart illustrating an example of change processing in the embodiment.

FIG. 7 is a flowchart illustrating an example of node deleting processing in the embodiment.

FIG. 8 is a flowchart illustrating an example of edge deleting processing in the embodiment.

FIG. 9 is a flowchart illustrating an example of sales information acquiring processing in the embodiment.

FIG. 10 is a flowchart illustrating an operation example of a terminal apparatus 2 in the embodiment.

FIGS. 11A to 11C are diagrams showing an example of business information in the embodiment.

FIG. 12 is a diagram showing an example of business information in the embodiment.

FIG. 13 is a diagram showing an output example of a graph in the embodiment.

FIG. 14 is a diagram showing an output example of a sales information management table in the embodiment.

FIG. 15 is a diagram showing an example of business information in the embodiment.

FIG. 16 is a diagram showing an example of business information in the embodiment.

FIG. 17 is a block diagram of a computer system in the embodiment.

### DETAILED DESCRIPTION OF THE INVENTION

Hereinafter, an embodiment of a business support apparatus and the like will be described with reference to the drawings. It should be noted that constituent elements denoted by the same reference numerals in the embodiments perform similar operations, and thus a description thereof may not be repeated.

### Embodiment 1

In this embodiment, a business support apparatus will be described that configures and outputs a graph that visually shows a business profit structure, using information on association between funnels, tiers, and revenues corresponding to one budget and transition probability. The term “one budget” may be considered to be synonymous with one organization. An organization is typically an organization that conducts business, and examples thereof include a company, an institution, a department of a company, a business office of a company, and a sole proprietor. A budget is a budget for conducting business and is a unit of business.

In this embodiment, a business support apparatus will be described that also manages leads time between a funnel and a tier and between a tier and a revenue, and outputs sales information for each month taking the lead times into account.

In this embodiment, a business support apparatus will be described that manages the unit price of each revenue and outputs the sales amount as well in association with the revenue.

In this embodiment, a business support apparatus will be described in which the output graph is editable and the managed business information is updated through editing of the graph.

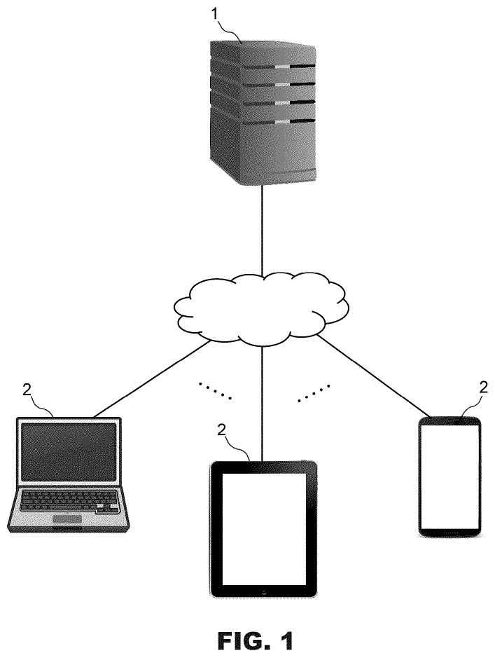

FIG. 1 is a conceptual diagram of a business support system A in this embodiment. The business support system A includes a business support apparatus 1 and one or two or more terminal apparatuses 2.

The business support apparatus 1 and each of the one or two or more terminal apparatuses 2 can communicate with each other typically via a network such as the Internet.

The business support apparatus 1 is a server that can manage business information for each of one or two or more budgets and provide users with graphs that graphically show the profit status of the business. The business support apparatus 1 can also be a terminal. If the business support apparatus 1 is a server, the business support apparatus 1 is, for example, an ASP server, a cloud server, or the like. If the business support apparatus 1 is a terminal, the business support apparatus 1 is, for example, a so-called personal computer, tablet terminal, smartphone, or the like. However, there is no limitation on the type of the business support apparatus 1.

The terminal apparatuses 2 are terminals through which business information is input and graphs are output, and are terminals that are used by users. The terminal apparatuses 2 are, for example, so-called personal computers, tablet terminals, smartphones, or the like, but there is no limitation on the type thereof. If the business support apparatus 1 is a terminal, the terminal apparatuses 2 are not necessary.

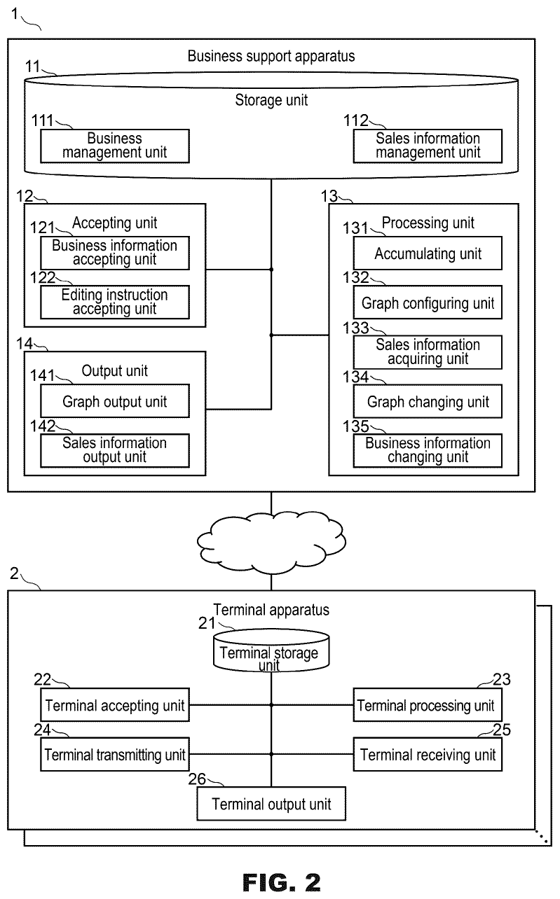

FIG. 2 is a block diagram of the business support system A in this embodiment. The business support apparatus 1 includes a storage unit 11, an accepting unit 12, a processing unit 13, and an output unit 14. The storage unit 11 includes a business management unit 111 and a sales information management unit 112. The accepting unit 12 includes a business information accepting unit 121 and an editing instruction accepting unit 122. The processing unit 13 includes an accumulating unit 131, a graph configuring unit 132, a sales information acquiring unit 133, a graph changing unit 134, and a business information changing unit 135. The output unit 14 includes a graph output unit 141 and a sales information output unit 142.

Each terminal apparatus 2 includes a terminal storage unit 21, a terminal accepting unit 22, a terminal processing unit 23, a terminal transmitting unit 24, a terminal receiving unit 25, and a terminal output unit 26.

Various types of information are stored in the storage unit 11 constituting the business support apparatus 1. The various types of information are, for example, later-described business information, later-described sales information, or budget identifiers. A budget identifier is information for identifying a budget. Alternatively, the budget identifier may be information for identifying an organization. The budget identifier is, for example, an ID, a budget name, or a company name.

One or two or more pieces of business information are stored in the business management unit 111. A budget identifier is associated with each of the one or two or more pieces of business information. For example, an organization identifier is associated with each of the one or two or more pieces of business information. The organization identifier is information for identifying an organization. The organization identifier is, for example, an organization ID or an organization name.

The business information contains one or two or more pieces of funnel information. The business information contains one or two or more pieces of tier information. The business information contains one or two or more pieces of revenue information. The business information contains, for example, one or two or more pieces of edge information. The business information contains one or two or more pieces of probability information. The probability information is, for example, later-described first probability information or later-described second probability information. The business information contains, for example, one or two or more lead times.

The funnel information is information on a funnel. The funnel is a starting stage among one or two or more stages related to business. The two or more stages have an order. The stages are, for example, actions related to business or information related to business. The funnel contains, for example, an entry action for business. The funnel is, for example, “app download”, “web page access”, “membership registration”, “agency referral”, or “trade show”. The funnel information contains a funnel name, a quantity, a lead time, an increase rate, a change rate, or a point of contact with another funnel. The action in this case is performed, for example, by a consumer, a business owner, or an agency.

Furthermore, multiple funnels and tiers can be collectively treated as a single funnel. For example, “SNA ad impressions” may be defined as a funnel A with “click”, “download”, and “membership registration” being defined in the lower-level tiers thereof, “offline event” may be defined as a funnel B with “application”, “participation (download)”, and “membership registration” being defined in the lower-level tiers thereof, and the final tiers “membership registration” may be collectively defined as a funnel C “total number of members” with “monthly number of users” being defined in the lower-level tier thereof.

The tier information is information on a tier. The tier is a stage subsequent to the funnel and prior to a sale. The term “subsequent” means later in time. The sale is the purchase of a product or service by a consumer. There can be tiers that originate from a funnel and extend in a linear or tree-like form as detailed stages at a level lower than that of the funnel. For example, “LP inflow” is defined as a funnel, and “click”, “application”, or the like is defined as a tier. The tier is, for example, “membership registration” or “payment information registration”. The tier information is, for example, associated with one or two or more pieces of funnel information. Tier information associated with funnel information is information on a tier that is performed after a funnel specified with that funnel information. One or two or more pieces of tier information may be associated with tier information. That is to say, a funnel and a tier may have a one-to-N (N is a natural number of 1 or more) relationship, and a tier and a tier may have an N-to-N relationship. The tier information has a tier name. The tier information has, for example, a quantity. The action in this case is performed, for example, by a consumer, a business owner, or an agency.

The revenue information is information on a revenue. The revenue is a commercial item or a category of commercial items subsequent to the tier. The revenue is, for example, something that generates a sales amount or an action that determines profits. The commercial item may be an action of a consumer. The action that determines profits can be said to be an action that is determined by the sale of a product or service. The category of commercial items is, for example, “high-priced product” or “low-priced product”. The revenue is, for example, “paid membership registration” or “product purchase”. The revenue information is associated with one or two or more pieces of tier information. Revenue information associated with tier information is information on a revenue that is performed after a tier specified with that tier information. The revenue information has a revenue name. The revenue information has, for example, a quantity. The revenue information has, for example, a unit price. The unit price is a unit price of a product or service corresponding to the revenue information.

The funnel information, the tier information, and the revenue information correspond to nodes in a graph, which will be described later. The funnel, the tier, and the revenue can be said to be an example of nodes. The funnel information, the tier information, and the revenue information can be said to be an example of node information.

The edge information is information on an edge. The edge associates, for example, a funnel that is performed earlier and a tier that is performed after the funnel. The edge associates, for example, a tier that is performed earlier and another tier that is performed after the tier. The edge associates, for example, a tier that is performed earlier and a revenue that is performed after the tier. The edge information contains information for specifying two nodes that are associated with each other. The edge information contains, for example, a funnel identifier and a tier identifier. The edge information contains, for example, a tier identifier and a tier identifier. The edge information contains, for example, a tier identifier and a revenue identifier.

The edge information can be said to contain, for example, a first identifier and a second identifier. The first identifier and the second identifier are information for identifying nodes. The first identifier identifies, for example, a node for an action that is performed before an action corresponding to a node identified with the second identifier is performed.

The funnel identifier is information for identifying a funnel. The funnel identifier is, for example, a funnel ID or a funnel name. The tier identifier is information for identifying a tier. The tier identifier is, for example, a tier ID or a tier name. The revenue identifier is information for identifying a revenue. The revenue identifier is, for example, a revenue ID or a revenue name.

The probability information is information indicating a probability that a subsequent action is performed with respect to the number of times that a prior action was performed (e.g., the number of users).

The first probability information is information on funnel information and tier information that are associated with each other, and is information for specifying a probability that a funnel specified with the funnel information is performed and then a tier specified with the tier information is performed. The first probability information is, for example, “50%” or “0.7”. The first probability information is, for example, contained in the edge information.

The second probability information is information on tier information and revenue information that are associated with each other, and is information for specifying a probability that a tier specified with the tier information is performed and then a revenue specified with the revenue information is performed. The second probability information may be information on tier information and tier information that are associated with each other, and may be information for specifying a probability that a tier specified with one of the pieces of tier information is performed and then a tier specified with the other piece of tier information is performed. The second probability information is, for example, “60%” or “0.3”. The second probability information is, for example, contained in the edge information.

The lead time is a period of time after a previous action is performed and before a next action is performed. The lead time is, for example, a period of time after a funnel is performed and before a tier is performed or a period of time after a tier is performed and before a revenue is performed. The lead time is, for example, “1 month”, “3 months”, or “0”.

One or two or more pieces of sales information are stored in the sales information management unit 112. The sales information is associated with a budget. The sales information may be associated with a revenue. The sales information is, for example, information indicating a sales amount of a product or service. The sales information is, for example, information indicating a sales quantity of a product or service. Typically, for one budget, sales information for each of two or more months is typically stored in the sales information management unit 112.

The accepting unit 12 accepts various types of information and instructions. The term “accept” in this case is, for example, receiving, but may be a concept that encompasses accepting information input from an input device such as a keyboard, a mouse, or a touch screen, accepting information read from a recording medium such as an optical disk, a magnetic disk, or a semiconductor memory, and the like. The various types of information and instructions are, for example, business information, an element that constitutes business information, a graph output instruction, a sales information output instruction, or a later-described editing instruction.

The graph output instruction is an instruction to output a graph. The graph output instruction has, for example, a budget identifier. The budget identifier may be the same as an organization identifier.

The sales information output instruction is an instruction to output sales information. The sales information output instruction has, for example, a budget identifier. The budget identifier may be the same as an organization identifier.

The business information accepting unit 121 accepts all or part of the business information. Part of the business information is an element that constitutes the business information. The element is, for example, all or part of the funnel information, all or part of the tier information, all or part of the revenue information, or all or part of the edge information. The term “accept” in this case is, for example, receiving.

The editing instruction accepting unit 122 accepts an editing instruction for the graph output by the graph output unit 141. The term “accept” in this case is, for example, receiving.

The editing instruction is an instruction to edit the graph output by the graph output unit 141. The editing instruction is, for example, a node adding instruction, a node deleting instruction, a node change instruction, an edge adding instruction, an edge deleting instruction, or an edge change instruction. The node adding instruction is an instruction to add a node. The node is a funnel, a tier, or a revenue. The node deleting instruction is an instruction to delete a node. The node change instruction is an instruction to change part or all of the node information. The edge adding instruction is an instruction to add the edge information. The edge deleting instruction is an instruction to delete the edge information. The edge change instruction is an instruction to change the edge information.

The processing unit 13 performs various types of processing. The various types of processing are, for example, processing that is performed by the accumulating unit 131, the graph configuring unit 132, the sales information acquiring unit 133, the graph changing unit 134, or the business information changing unit 135.

The accumulating unit 131 accumulates part or all of the business information accepted by the business information accepting unit 121, in the business management unit 111. There is no limitation on the structure of the business information that is accumulated by the accumulating unit 131. The accumulating unit 131 accumulates, for example, a later-described funnel management table, a later-described tier management table, a later-described revenue management table, and a later-described edge management table. The accumulating unit 131 accumulates a business information, for example, in a later-described JSON format.

The graph configuring unit 132 configures a graph. The graph is a diagram of a network structure with nodes and edges. The edges in this case are typically directed. For example, in response to acceptance of a graph output instruction, the graph configuring unit 132 configures a graph showing a profit structure that can be read from information contained in the business information on the budget corresponding to the graph output instruction.

The graph configuring unit 132 configures a graph in which, for example, a node of the funnel information, a node of the tier information, and a node of the revenue information are respectively associated with a funnel name and a quantity thereof, a tier name and a quantity thereof, and a revenue name and a quantity thereof.

The graph configuring unit 132 preferably configures a graph in which nodes of any type among the funnel information, the tier information, and the revenue information have an outline that is different depending on the type of node. Different outline means different node attribute values. The node attribute values are, for example, the shape of the node, the background color of the node, the font of the string in the node, or the font color of the string in the node.

The graph configuring unit 132 configures a graph in which, for example, for each of one or two or more pieces of revenue information, a sales amount obtained by multiplying a unit price and a quantity is associated with a node of the revenue information.

The sales information acquiring unit 133 acquires sales information for each of two or more months, using a quantity corresponding to each of the one or two or more revenues and the lead time. There is no limitation on the trigger for the sales information acquiring unit 133 to acquire sales information. The trigger is, for example, that business information is accepted by the business information accepting unit 121, that a sales information acquiring instruction is accepted by the accepting unit 12, or that a predetermined time (e.g., 12:00 on the first day of each month) is reached.

The graph changing unit 134 changes the graph output by the graph output unit 141 in response to the editing instruction accepted by the editing instruction accepting unit 122. The graph changing unit 134 changes the output of the output graph.

The business information changing unit 135 changes the business information in the business management unit 111 in response to the change made by the graph changing unit 134.

The output unit 14 outputs various types of information. The various types of information are, for example, a graph or sales information. The term “output” in this case is, for example, transmission to the terminal apparatus 2, but may be a concept that encompasses display on a display screen, projection using a projector, printing by a printer, output of a sound, accumulation in a recording medium, and delivery of a processing result to another processing apparatus or another program.

The graph output unit 141 outputs the graph configured by the graph configuring unit 132. For example, the graph output unit 141 transmits the graph configured by the graph configuring unit 132, to the terminal apparatus 2.

The sales information output unit 142 outputs the sales information for each month acquired by the sales information acquiring unit 133. For example, the sales information output unit 142 transmits the sales information for each month acquired by the sales information acquiring unit 133, to the terminal apparatus 2.

Various types of information are stored in the terminal storage unit 21 constituting the terminal apparatus 2. The various types of information are, for example, a company identifier or a budget identifier.

The terminal accepting unit 22 accepts input of instructions, information, and the like from a user. The instructions, information, and the like are, for example, business information, an element that constitutes business information, a graph output instruction, a sales information output instruction, or an editing instruction. The instructions, information, and the like may be input by any input part such as a touch screen, a keyboard, a mouse, or a menu screen.

The instructions, information, and the like may be input by any input part such as a touch screen, a keyboard, a mouse, or a menu screen.

The terminal processing unit 23 performs various types of processing. The various types of processing are, for example, processing that changes the instructions, information, and the like accepted by the terminal accepting unit 22 into instructions, information, and the like with a structure for transmission, processing that changes the information received by the terminal receiving unit 25 into information with a structure for output, or the like.

The terminal transmitting unit 24 transmits various types of information, instructions, and the like to the business support apparatus 1. The various types of information, instructions, and the like are, for example, business information, an element that constitutes business information, an output instruction, or an editing instruction.

The terminal receiving unit 25 receives various types of information from the business support apparatus 1. The various types of information are, for example, a graph or sales information.

The terminal output unit 26 outputs various types of information. The various types of information are, for example, a graph or sales information. The term “output” in this case is, for example, display on a display screen, but may be a concept that encompasses projection using a projector, printing by a printer, output of a sound, accumulation in a recording medium, transmission to another processing apparatus, and delivery of a processing result to another processing apparatus or another program.

The storage unit 11, the business management unit 111, the sales information management unit 112, and the terminal storage unit 21 are preferably non-volatile recording media, but they may alternately be realized by volatile recording media.

There is no limitation on the procedure in which information is stored in the storage unit 11 and the like. For example, information may be stored in the storage unit 11 and the like via a recording medium, information transmitted via a communication line or the like may be stored in the storage unit 11 and the like, or information input via an input device may be stored in the storage unit 11 and the like.

The accepting unit 12, the business information accepting unit 121, and the editing instruction accepting unit 122 are typically realized by wireless or wired communication parts. However, the accepting unit 12 and the like may be realized by a device driver for an input part such as a touch screen or a keyboard, control software for a menu screen, or the like.

The processing unit 13, the accumulating unit 131, the graph configuring unit 132, the sales information acquiring unit 133, the graph changing unit 134, the business information changing unit 135, and the terminal processing unit 23 may be typically realized by processors, memories, or the like. Typically, the processing procedure of the processing unit 13 and the like is realized by software, and the software is stored in a recording medium such as a ROM. However, the processing procedure may be realized by hardware (dedicated circuits). The processors are, for example, CPUs, MPUs, GPUs, or the like, but there is no limitation on the type thereof.

The output unit 14, the graph output unit 141, and the sales information output unit 142 are typically realized by wireless or wired communication parts. However, the output unit 14 and the like may be realized by driver software for an output device such as a display screen or a speaker, a combination of driver software for an output device and the output device, or the like.

The terminal accepting unit 22 may be realized by a device driver for an input part such as a touch screen or a keyboard, control software for a menu screen, or the like.

The terminal transmitting unit 24 is typically realized by a wireless or wired communication part, but it may also be realized by a broadcasting part.

The terminal receiving unit 25 is typically realized by a wireless or wired communication part, but it may also be realized by a broadcast receiving part.

The terminal output unit 26 may be considered to include or to not include an output device such as a display screen or a speaker. The terminal output unit 26 may be realized by driver software for an output device, a combination of driver software for an output device and the output device, or the like.

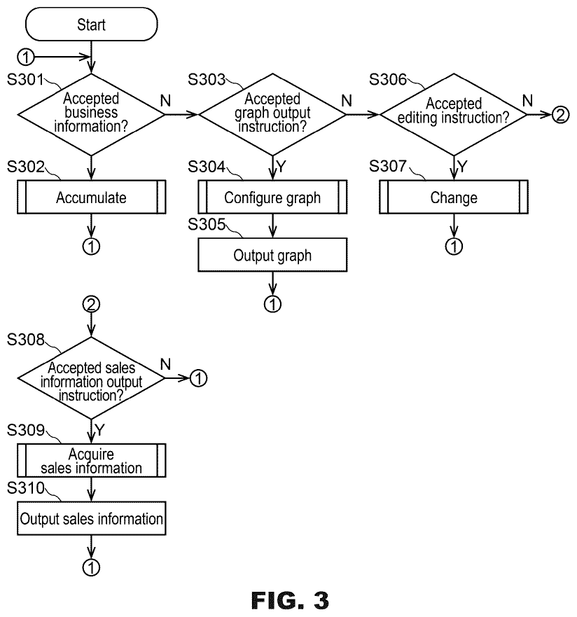

Next, an operation example of the business support apparatus 1 will be described with reference to the flowchart in FIG. 3.

(Step S301) The business information accepting unit 121 determines whether or not it has accepted business information. If it has accepted business information, the procedure advances to step S302, or otherwise the procedure advances to step S303. For example, the business information accepting unit 121 determines whether or not it has received business information from the terminal apparatus 2.

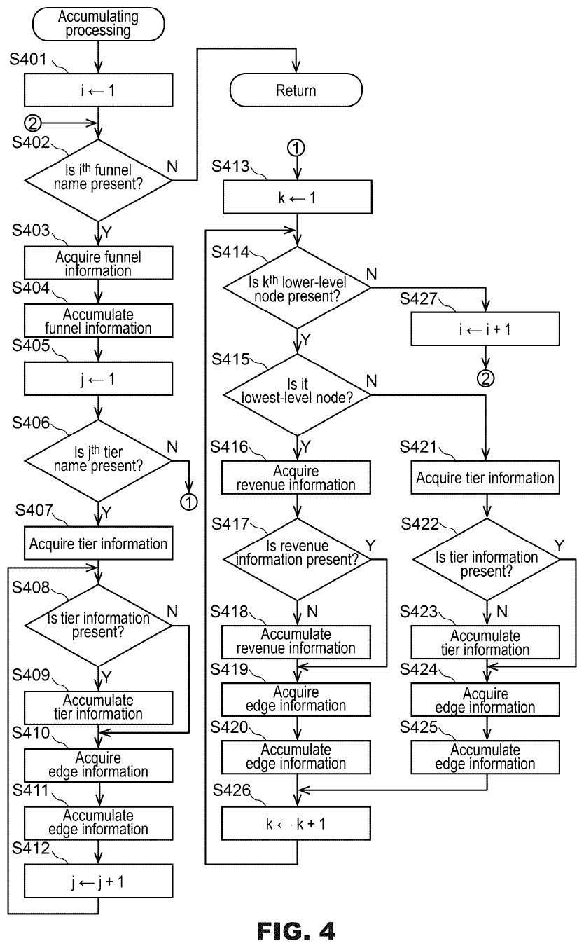

(Step S302) The accumulating unit 131 accumulates the business information accepted in step S301, in the business management unit 111. The procedure returns to step S301. An example of the accumulating processing will be described later with reference to the flowchart in FIG. 4.

(Step S303) The accepting unit 12 determines whether or not it has accepted a graph output instruction. If it has accepted a graph output instruction, the procedure advances to step S304, or otherwise the procedure advances to step S306. For example, the accepting unit 12 determines whether or not it has received a graph output instruction from the terminal apparatus 2.

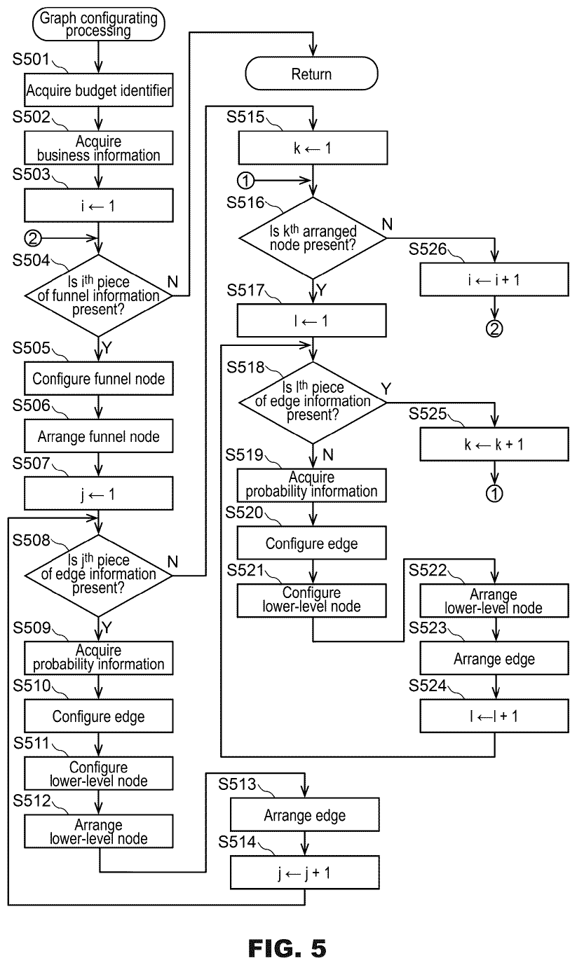

(Step S304) The graph configuring unit 132 configures a graph. An example of the graph configurating processing will be described later with reference to the flowchart in FIG. 5.

(Step S305) The graph output unit 141 outputs the graph configured in step S304. The procedure returns to step S301. For example, the graph output unit 141 transmits the graph to the terminal apparatus 2.

(Step S306) The editing instruction accepting unit 122 determines whether or not it has accepted an editing instruction. If it has accepted an editing instruction, the procedure advances to step S307, or otherwise the procedure advances to step S308. For example, the editing instruction accepting unit 122 determines whether or not it has received an editing instruction from the terminal apparatus 2.

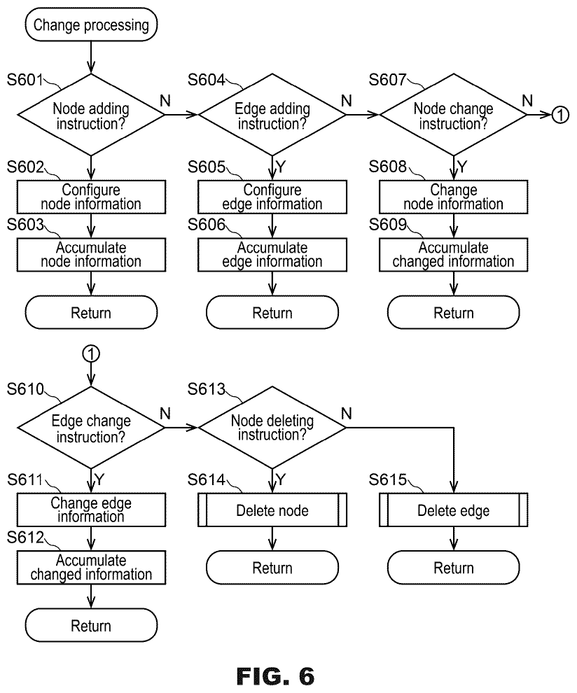

(Step S307) The business information changing unit 135 changes the business information. The procedure returns to step S301. An example of the change processing will be described later with reference to the flowchart in FIG. 6.

(Step S308) The accepting unit 12 determines whether or not it has accepted a sales information output instruction. If it has accepted a sales information output instruction, the procedure advances to step S309, or otherwise the procedure returns to step S301. For example, the accepting unit 12 determines whether or not it has received a sales information output instruction from the terminal apparatus 2.

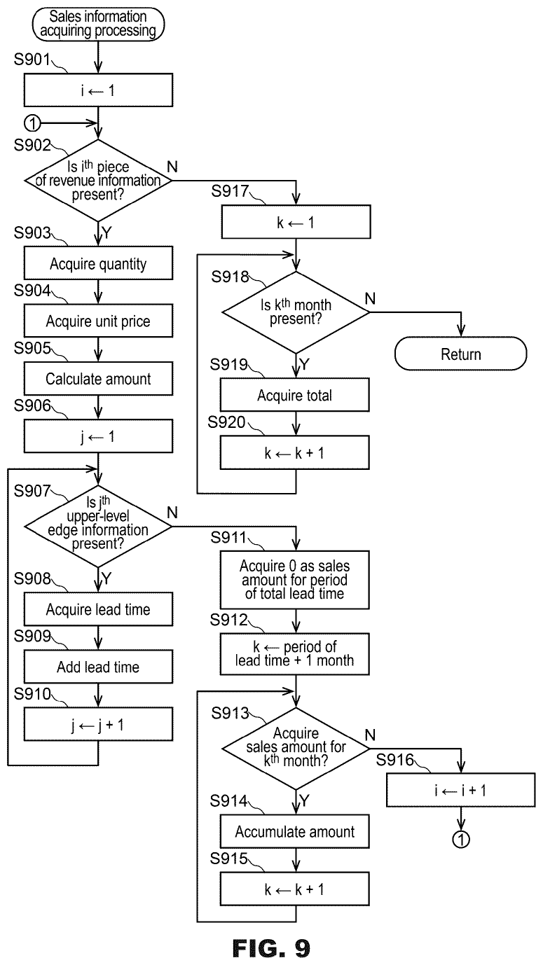

(Step S309) The sales information acquiring unit 133 acquires sales information. An example of the sales information acquiring processing will be described later with reference to the flowchart in FIG. 9.

(Step S310) The sales information output unit 142 outputs the sales information acquired in step S309. The procedure returns to step S301. For example, the sales information output unit 142 transmits the sales information to the terminal apparatus 2.

In the flowchart in FIG. 3, the processing ends at power off or at an interruption of terminating processing.

Next, an example of the accumulating processing in step S302 will be described with reference to the flowchart in FIG. 4.

(Step S401) The accumulating unit 131 substitutes 1 for a counter i.

(Step S402) The accumulating unit 131 determines whether or not an i^{th} funnel name is contained in the accepted business information. If an i^{th} funnel name is contained, the procedure advances to step S403, or otherwise the procedure returns to the upper-level processing.

(Step S403) The accumulating unit 131 acquires a unique funnel identifier. The accumulating unit 131 configures funnel information having the funnel identifier and the i^{th} funnel name. The funnel information contains, for example, the quantity contained in the accepted business information and corresponding to the i^{th} funnel name.

(Step S404) The accumulating unit 131 accumulates the funnel information configured in step S403, in the business management unit 111.

(Step S405) The accumulating unit 131 substitutes 1 for a counter j.

(Step S406) The accumulating unit 131 determines whether or not a j^{th} tier name corresponding to the i^{th} funnel name is contained in the accepted business information. If a j^{th} tier name corresponding to the i^{th} funnel name is contained, the procedure advances to step S407, or otherwise the procedure advances to step S413.

(Step S407) The accumulating unit 131 configures tier information having the tier identifier and the j^{th} tier name. The tier information contains, for example, the quantity contained in the accepted business information and corresponding to the j^{th} tier name.

(Step S408) The accumulating unit 131 determines whether or not the tier information configured in step S407 is present in the business management unit 111. If the tier information is present in the business management unit 111, the procedure advances to step S410, or otherwise the procedure advances to step S409. The comparison in this case does not use the tier identifier.

(Step S409) The accumulating unit 131 acquires a unique tier identifier. The accumulating unit 131 configures tier information having the tier identifier and the information acquired in step S407, and accumulates the tier information in the business management unit 111.

(Step S410) The accumulating unit 131 acquires edge information on an edge that links the i^{th} piece of funnel information and the j^{th} piece of tier information. The edge information has, for example, a funnel identifier contained in the i^{th} piece of funnel information and a tier identifier contained in the j^{th} piece of tier information. The edge information has, for example, probability information. The probability information is, for example, “quantity contained in j^{th} piece of tier information/quantity contained in i^{th} piece of funnel information”.

(Step S411) The accumulating unit 131 accumulates the edge information acquired in step S410, in the business management unit 111.

(Step S412) The accumulating unit 131 increments the counter j by 1. The procedure returns to step S406.

(Step S413) The accumulating unit 131 substitutes 1 for a counter k.

(Step S414) The accumulating unit 131 determines whether or not a k^{th} lower-level node is present in the accepted business information. If a k^{th} lower-level node is present, the procedure advances to step S415, or otherwise the procedure advances to step S427. The lower-level node is tier information or revenue information.

(Step S415) The accumulating unit 131 determines whether or not the k^{th} lower-level node is a lowest-level node. If it is a lowest-level node, the procedure advances to step S416, or otherwise the procedure advances to step S421.

(Step S416) The accumulating unit 131 configures revenue information having a revenue name, which is a name (character string) contained in the information on the k^{th} lower-level node. The revenue information has, for example, a quantity and a unit price.

(Step S417) The accumulating unit 131 determines whether or not the same revenue information as the revenue information configured in step S416 is present in the business management unit 111. If the same revenue information is present, the procedure advances to step S419, or otherwise the procedure advances to step S419. The comparison in this case does not use the revenue identifier.

(Step S418) The accumulating unit 131 acquires a unique revenue identifier. Then, revenue information having the revenue identifier and the revenue name and the like acquired in step S416 is configured and accumulated in the business management unit 111.

(Step S419) The accumulating unit 131 acquires an identifier of an upper-level node of the k^{th} lower-level node. The accumulating unit 131 acquires edge information having the identifier of the upper-level node and the identifier of the k^{th} lower-level node. The edge information has, for example, probability information. The probability information is, for example, “quantity contained in node information on k^{th} lower-level node/quantity contained in node information on upper-level node thereof”.

(Step S420) The accumulating unit 131 accumulates the edge information acquired in step S419, in the business management unit 111.

(Step S421) The accumulating unit 131 configures tier information having a tier name, which is a name (character string) contained in the information on the k^{th} lower-level node. The tier information has, for example, a quantity.

(Step S422) The accumulating unit 131 determines whether or not the same tier information as the tier information configured in step S421 is present in the business management unit 111. If the same tier information is present, the procedure advances to step S424, or otherwise the procedure advances to step S423. The comparison in this case does not use the tier identifier.

(Step S423) The accumulating unit 131 acquires a unique tier identifier. Then, tier information having the tier identifier and the tier name and the like acquired in step S422 is configured and accumulated in the business management unit 111.

(Step S424) The accumulating unit 131 acquires an identifier of an upper-level node of the k^{th} lower-level node. The accumulating unit 131 acquires edge information having the identifier of the upper-level node and the identifier of the k^{th} lower-level node. The edge information has, for example, probability information. The probability information is, for example, “quantity contained in node information on k^{th} lower-level node/quantity contained in node information on upper-level node thereof”.

(Step S425) The accumulating unit 131 accumulates the edge information acquired in step S424, in the business management unit 111.

(Step S426) The accumulating unit 131 increments the counter k by 1. The procedure returns to step S414.

(Step S427) The accumulating unit 131 increments the counter i by 1. The procedure returns to step S402.

In the flowchart in FIG. 4, only a tier can be connected to a revenue, but it is also possible that a funnel, a tier, or a revenue can be connected to a revenue.

Next, an example of the graph configurating processing in step S304 will be described with reference to the flowchart in FIG. 5.

(Step S501) The graph configuring unit 132 acquires a budget identifier contained in the graph output instruction.

(Step S502) The graph configuring unit 132 acquires business information that is paired with the budget identifier, from the business management unit 111.

(Step S503) The graph configuring unit 132 substitutes 1 for a counter i.

(Step S504) The graph configuring unit 132 determines whether or not an i^{th} piece of funnel information is present in the business information acquired in step S502. If an i^{th} piece of funnel information is present, the procedure advances to step S505, or otherwise the procedure returns to the upper-level processing.

(Step S505) The graph configuring unit 132 configures a funnel node corresponding to the i^{th} piece of funnel information. The funnel node has an outline corresponding to the funnel information.

(Step S506) The graph configuring unit 132 arranges the i^{th} funnel node.

(Step S507) The graph configuring unit 132 substitutes 1 for a counter j.

(Step S508) The graph configuring unit 132 determines whether or not a j^{th} piece of edge information is present in the edge information that is contained in the business information acquired in step S502 and that contains the funnel identifier contained in the i^{th} piece of funnel information. If a j^{th} piece of edge information is present, the procedure advances to step S509, or otherwise the procedure advances to step S515.

(Step S509) The graph configuring unit 132 acquires probability information contained in the j^{th} piece of edge information.

(Step S510) The graph configuring unit 132 configures an edge having the probability information.

(Step S511) The graph configuring unit 132 acquires a node identifier of the other node contained in the j^{th} piece of edge information. The graph configuring unit 132 acquires node information corresponding to the node identifier from the business information acquired in step S502. The graph configuring unit 132 configures a lower-level node using the node information.

(Step S512) The graph configuring unit 132 arranges the node configured in step S511.

(Step S513) The graph configuring unit 132 arranges the edge configured in step S510, at the position connecting the two nodes.

(Step S514) The graph configuring unit 132 increments the counter j by 1. The procedure returns to step S508.

(Step S515) The graph configuring unit 132 substitutes 1 for a counter k.

(Step S516) The graph configuring unit 132 determines whether or not a k^{th} lower-level node that has been arranged is present. If such a k^{th} lower-level node is present, the procedure advances to step S517, or otherwise the procedure advances to step S526.

(Step S517) The graph configuring unit 132 substitutes 1 for a counter l.

(Step S518) The graph configuring unit 132 determines whether or not an l^{th} piece of edge information is present. If an l^{th} piece of edge information is present, the procedure advances to step S519, or otherwise the procedure advances to step S525.

(Step S519) The graph configuring unit 132 acquires probability information contained in the l^{th} piece of edge information.

(Step S520) The graph configuring unit 132 configures an edge having the probability information.

(Step S521) The graph configuring unit 132 acquires a node identifier of the other node contained in the l^{th} piece of edge information. The graph configuring unit 132 acquires node information corresponding to the node identifier. The graph configuring unit 132 configures a node using the node information.

(Step S522) The graph configuring unit 132 arranges the node configured in step S521.

(Step S523) The graph configuring unit 132 arranges the edge configured in step S520.

(Step S524) The graph configuring unit 132 increments the counter 1 by 1. The procedure returns to step S518.

(Step S525) The graph configuring unit 132 increments the counter k by 1. The procedure returns to step S516.

(Step S526) The graph configuring unit 132 increments the counter i by 1. The procedure returns to step S504.

Next, an example of the change processing in step S307 will be described with reference to the flowchart in FIG. 6.

(Step S601) The graph changing unit 134 determines whether or not the editing instruction is a node adding instruction. If it is a node adding instruction, the procedure advances to step S602, or otherwise the procedure advances to step S604.

(Step S602) The graph changing unit 134 acquires a funnel name, a tier name, or a revenue name contained in the node adding instruction, and configures node information having the funnel name, the tier name, or the revenue name.

(Step S603) The graph changing unit 134 accumulates the node information configured in step S602, in the business management unit 111. The procedure returns to the upper-level processing.

(Step S604) The graph changing unit 134 determines whether or not the editing instruction is an edge adding instruction. If it is an edge adding instruction, the procedure advances to step S605, or otherwise the procedure advances to step S607.

(Step S605) The graph changing unit 134 configures edge information having two node identifiers contained in the edge adding instruction.

(Step S606) The graph changing unit 134 accumulates the edge information configured in step S605, in the business management unit 111. The procedure returns to the upper-level processing.

(Step S607) The graph changing unit 134 determines whether or not the editing instruction is a node change instruction. If it is a node change instruction, the procedure advances to step S608, or otherwise the procedure advances to step S610.

(Step S608) The graph changing unit 134 acquires node information that is changed in response to the node change instruction.

(Step S609) The graph changing unit 134 accumulates the node information acquired in step S608, and updates the node information that is to be changed. The procedure returns to the upper-level processing.

(Step S610) The graph changing unit 134 determines whether or not the editing instruction is an edge change instruction. If it is an edge change instruction, the procedure advances to step S611, or otherwise the procedure advances to step S613.

(Step S611) The graph changing unit 134 acquires edge information that is changed in response to the edge change instruction.

(Step S612) The graph changing unit 134 accumulates the edge information acquired in step S611, and updates the edge information that is to be changed. The procedure returns to the upper-level processing.

(Step S613) The graph changing unit 134 determines whether or not the editing instruction is a node deleting instruction. If it is a node deleting instruction, the procedure advances to step S614, or otherwise the procedure advances to step S615. In this case, if the editing instruction is not a node deleting instruction, the editing instruction is an edge deleting instruction.

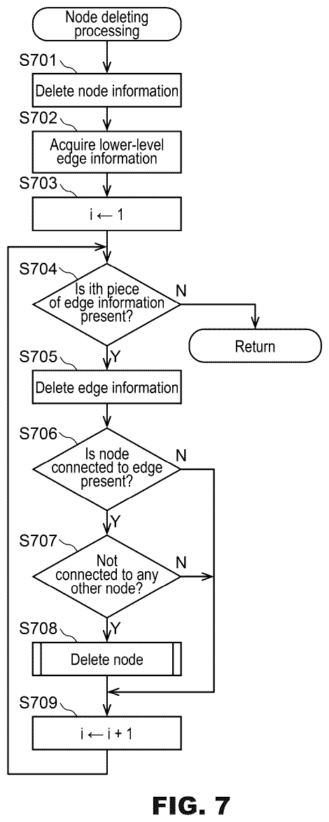

(Step S614) The graph changing unit 134 performs, according to the node deleting instruction, node deleting processing that deletes a node specified with the node deleting instruction, an edge at a level lower than that of the node, and a node located at a level lower than that of the node and not connected to others. The procedure returns to the upper-level processing. An example of the node deleting processing will be described later with reference to the flowchart in FIG. 7.

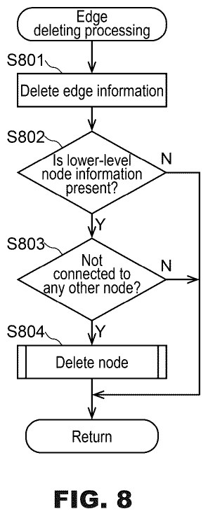

(Step S615) The graph changing unit 134 performs, according to the edge deleting instruction, edge deleting processing that deletes an edge specified with the edge deleting instruction and a node located at a level lower than that of the edge and not connected to others. The procedure returns to the upper-level processing. An example of the edge deleting processing will be described later with reference to the flowchart in FIG. 8.

Next, an example of the node deleting processing in step S614 will be described with reference to the flowchart in FIG. 7.

(Step S701) The graph changing unit 134 deletes node information identified with the node identifier contained in the node deleting instruction, from the business management unit 111.

(Step S702) The graph changing unit 134 acquires one or more pieces of lower-level edge information connected to the node information deleted in step S701, from the business management unit 111.

(Step S703) The graph changing unit 134 substitutes 1 for a counter i.

(Step S704) The graph changing unit 134 determines whether or not an i^{th} piece of edge information is present in the edge information acquired in step S702. If an i^{th} piece of edge information is present, the procedure advances to step S705, or otherwise the procedure returns to the upper-level processing.

(Step S705) The graph changing unit 134 deletes the i^{th} piece of edge information from the business management unit 111.

(Step S706) The graph changing unit 134 determines whether or not another node connected to an edge specified with the i^{th} piece of edge information is present. If the other node is present, the procedure advances to step S707, or otherwise the procedure advances to step S709.

(Step S707) The graph changing unit 134 determines whether or not the other node is connected to any nodes other than the node deleted in step S701. If it is not connected to any nodes other than the node deleted in step S701, the procedure advances to step S708, or otherwise the procedure advances to step S709.

(Step S708) The graph changing unit 134 performs node deleting processing on the other node.

(Step S709) The graph changing unit 134 increments the counter i by 1. The procedure returns to step S704.

Next, an example of the edge deleting processing in step S615 will be described with reference to the flowchart in FIG. 8.

(Step S801) The graph changing unit 134 deletes the edge information targeted for the edge deleting instruction, from the business management unit 111.

(Step S802) The graph changing unit 134 determines whether or not a lower-level node connected to the edge is present. If such a node is present, the procedure advances to step S803, or otherwise the procedure returns to the upper-level processing.

(Step S803) The graph changing unit 134 determines whether or not the lower-level node connected to the edge is connected to another node. If it is connected to another node, the procedure returns to the upper-level processing, or otherwise the procedure advances to step S804.

(Step S804) The graph changing unit 134 performs processing that deletes the lower-level node connected to the edge. This node deleting processing was described with reference to the flowchart in FIG. 7.

Next, an example of the sales information acquiring processing in step S309 will be described with reference to the flowchart in FIG. 9.

(Step S901) The sales information acquiring unit 133 substitutes 1 for a counter i.

(Step S902) The sales information acquiring unit 133 determines whether or not an i^{th} piece of revenue information is present in the business management unit 111. If an i^{th} piece of revenue information is present, the procedure advances to step S903, or otherwise the procedure advances to step S917.

(Step S903) The sales information acquiring unit 133 acquires a quantity contained in the i^{th} piece of revenue information.

(Step S904) The sales information acquiring unit 133 acquires a unit price contained in the i^{th} piece of revenue information.

(Step S905) The sales information acquiring unit 133 calculates the amount (quantity×unit price) corresponding to the i^{th} piece of revenue information.

(Step S906) The sales information acquiring unit 133 substitutes 1 for a counter j.

(Step S907) The sales information acquiring unit 133 determines whether or not a j^{th} upper-level edge information that connects the i^{th} piece of revenue information is present in the business management unit 111. If such an upper-level edge information is present, the procedure advances to step S908, or otherwise the procedure advances to step S911.

(Step S908) The sales information acquiring unit 133 acquires a lead time contained in the upper-level edge information.

(Step S909) The sales information acquiring unit 133 adds the lead time acquired in step S908.

(Step S910) The sales information acquiring unit 133 increments the counter j by 1. The procedure returns to step S907.

(Step S911) The sales information acquiring unit 133 acquires a sales amount “0” for the period of the total lead time. The period of the total lead time is the period of time ultimately calculated in step S909.

(Step S912) The sales information acquiring unit 133 substitutes “period of lead time+1 month” for a counter k.

(Step S913) The sales information acquiring unit 133 determines whether or not to acquire a sales amount for a k^{th} month. If a sales amount for a k^{th} month is to be acquired, the procedure advances to step S914, or otherwise the procedure advances to step S916. The maximum value of k is predetermined. The maximum value of k is, for example, 12 months or 24 months.

(Step S914) The sales information acquiring unit 133 accumulates the amount calculated in step S905, in an unshown buffer, as the sales amount for the k^{th} month. The sales information acquiring unit 133 may acquire the accumulated amount as the sales amount for the k^{th} month.

(Step S915) The sales information acquiring unit 133 increments the counter k by 1. The procedure returns to step S913.

(Step S916) The sales information acquiring unit 133 increments the counter i by 1. The procedure returns to step S902.

(Step S917) The sales information acquiring unit 133 substitutes 1 for a counter k.

(Step S918) The sales information acquiring unit 133 determines whether or not a k^{th} month for calculating the total sales amount is present. The maximum value of k is predetermined. The maximum value of k is, for example, 12 months or 24 months.

(Step S919) The sales information acquiring unit 133 acquires the total amount for the k^{th} month for two or more revenues and accumulates it in an unshown buffer in association with k.

(Step S920) The sales information acquiring unit 133 increments the counter k by 1. The procedure returns to step S918.

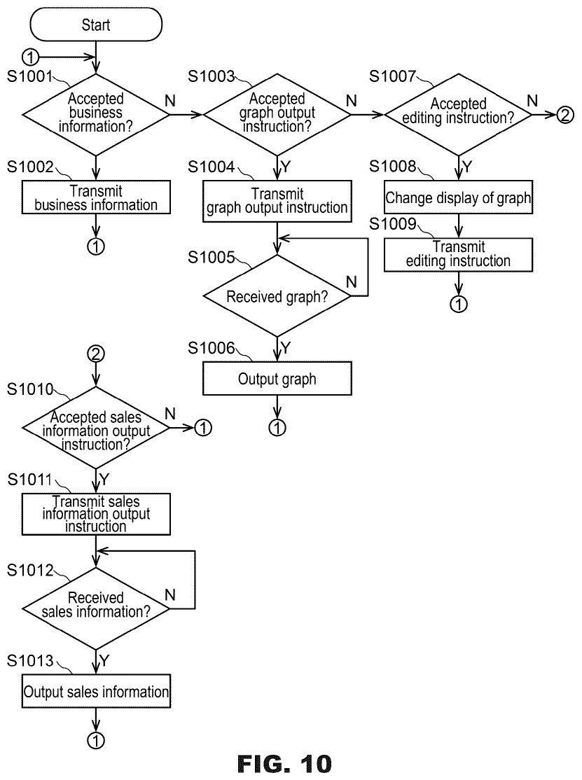

Next, an operation example of the terminal apparatus 2 will be described with reference to the flowchart in FIG. 10.

(Step S1001) The terminal accepting unit 22 determines whether or not it has accepted business information. If it has accepted business information, the procedure advances to step S1002, or otherwise the procedure advances to step S1003.

(Step S1002) The terminal processing unit 23 acquires a budget identifier from the terminal storage unit 21. The terminal processing unit 23 associates the business information accepted in step S1001 with the budget identifier. The terminal transmitting unit 24 transmits the business information associated with the budget identifier, to the business support apparatus 1. The procedure returns to step S1001.

(Step S1003) The terminal accepting unit 22 determines whether or not it has accepted a graph output instruction. If it has accepted a graph output instruction, the procedure advances to step S1004, or otherwise the procedure advances to step S1007.

(Step S1004) The terminal processing unit 23 acquires a budget identifier from the terminal storage unit 21. The terminal processing unit 23 configures a graph output instruction having the budget identifier. The terminal transmitting unit 24 transmits the graph output instruction to the business support apparatus 1.

(Step S1005) The terminal receiving unit 25 determines whether or not it has received a graph from the business support apparatus 1. If it has received a graph, the procedure advances to step S1006, or otherwise the procedure returns to step S1005.

(Step S1006) The terminal processing unit 23 configures a graph that is to be output, based on the received graph. The terminal output unit 26 outputs the graph. The procedure returns to step S1001.

(Step S1007) The terminal accepting unit 22 determines whether or not it has accepted an editing instruction. If it has accepted an editing instruction, the procedure advances to step S1008, or otherwise the procedure advances to step S1010.

(Step S1008) The terminal processing unit 23 changes the display of the output graph in response to the editing instruction.

(Step S1009) The terminal processing unit 23 acquires a budget identifier corresponding to the output graph. The terminal processing unit 23 associates the editing instruction with the budget identifier. The terminal transmitting unit 24 transmits the editing instruction associated with the budget identifier, to the business support apparatus 1. The procedure returns to step S1001.

(Step S1010) The terminal accepting unit 22 determines whether or not it has accepted a sales information output instruction. If it has accepted a sales information output instruction, the procedure advances to step S1011, or otherwise the procedure returns to step S1001.

(Step S1011) The terminal processing unit 23 acquires a budget identifier from the terminal storage unit 21. The terminal processing unit 23 configures a sales information output instruction having the budget identifier. The terminal transmitting unit 24 transmits the sales information output instruction to the business support apparatus 1.

(Step S1012) The terminal receiving unit 25 determines whether or not it has received sales information from the business support apparatus 1. If it has received sales information, the procedure advances to step S1013, or otherwise the procedure returns to step S1012.

(Step S1013) The terminal processing unit 23 configures sales information that is to be output, based on the received sales information. The terminal output unit 26 outputs the sales information. The procedure returns to step S1001.

In the flowchart in FIG. 10, the processing ends at power off or at an interruption of terminating processing.

Hereinafter, a specific operation example of the business support system A in this embodiment will be described.

It is assumed that a user has input a company identifier “company C”, a budget identifier “C1”, two pieces of funnel information, five pieces of tier information, and two pieces of revenue information to the terminal apparatus 2 on which a screen for inputting business information is output. Furthermore, it is assumed that the screen is a screen on which the connection between the funnel information and the tier information and the revenue information can be also seen. In this case, the funnel information input by the user has “funnel name” and “quantity”. The tier information input by the user has a tier name and a quantity. The revenue information input by the user has a revenue name, a quantity, and a unit price. With regard to the connection between the funnel information and the tier information and the revenue information, it is assumed that information is input such that the user can see upper-level node information (funnel information, tier information, or revenue information), lower-level node information connected to the upper-level node information, a probability of the transition to the lower-level node information connected to the upper-level node information, and the lead time.

Next, the terminal apparatus 2 accepts business information. The terminal apparatus 2 accepts business information associated with the company identifier “company C” and the budget identifier “C1”, and transmits the business information associated with the company identifier “company C” and the budget identifier “C1”, to the business support apparatus 1.

Next, the business information accepting unit 121 of the business support apparatus 1 receives the business information associated with the company identifier “company C” and the budget identifier “C1”.

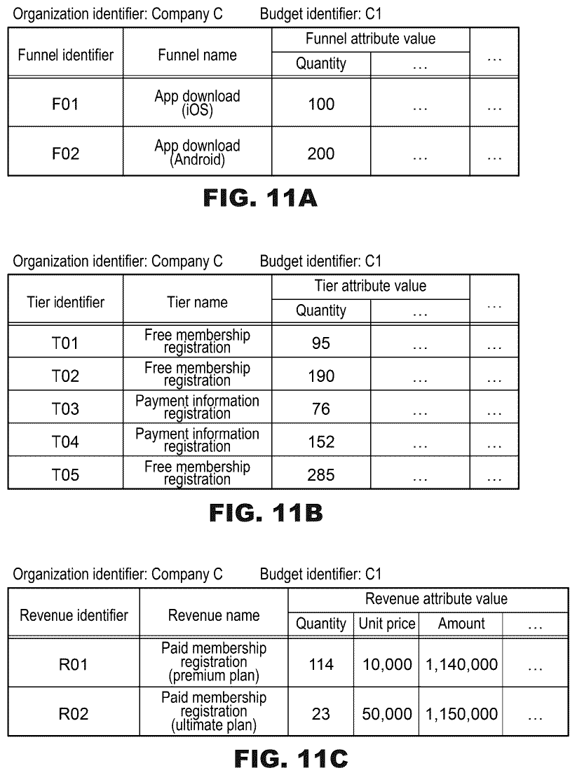

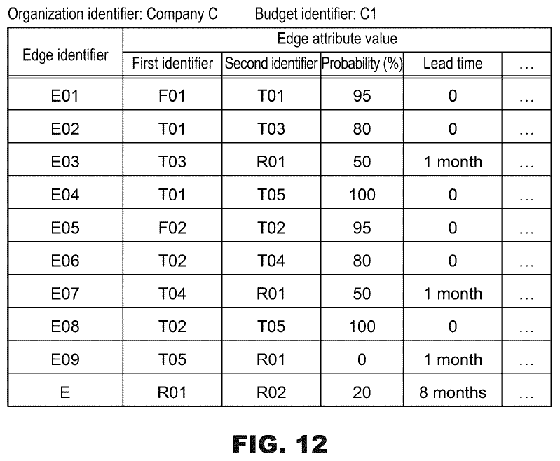

Next, the accumulating unit 131 accumulates the received business information in the business management unit 111 in association with the company identifier “company C” and the budget identifier “C1”. As a result, the business information in FIGS. 11A to 11C and 12 is stored in the business management unit 111.

FIG. 11A is a funnel management table for managing the funnel information. The funnel management table manages two or more records each having “funnel identifier”, “funnel name”, and “funnel attribute value”. “Funnel attribute value” has “quantity”.

FIG. 11B is a tier management table for managing the tier information. The tier management table manages two or more records each having “tier identifier”, “tier name”, and “tier attribute value”. “Tier attribute value” has “quantity”. The record with the tier identifier “T05” in FIG. 11B may be present in the funnel management table in FIG. 11A. That is to say, “free membership registration” of T05 may also be a funnel.

FIG. 11C is a revenue management table for managing the revenue information. The revenue management table manages two or more records each having “revenue identifier”, “revenue name”, and “revenue attribute value”. “Revenue attribute value” has “quantity”, “unit price”, and “amount”.

FIG. 12 is an edge management table for managing the edges. The edges in this case are, for example, an edge connecting the funnel information and the tier information, an edge connecting the tier information and the tier information, or an edge connecting the tier information and the revenue information. The edge management table manages two or more records each having “edge identifier” and “edge attribute value”. “Edge attribute value” has “first identifier”, “second identifier”, “probability (%)”, and “lead time”. “First identifier” is a node identifier of an upper-level node connected by an edge. “Second identifier” is a node identifier of a lower-level node connected by an edge. The node identifier is a funnel identifier, a tier identifier, or a revenue identifier. “Probability (%)” is a probability of the transition from the first node that is identified with the first identifier to the second node that is identified with the second identifier. “Lead time” is a period of time (in this case, months) necessary for the transition from the first node that is identified with the first identifier to the second node that is identified with the second identifier.

It is also possible that the funnel attribute value “quantity” in FIG. 11A and “probability (%)” in FIG. 12 are input by the user, and the tier attribute value “quantity” in FIG. 11B is automatically calculated and accumulated. It is also possible that the funnel attribute value “quantity” in FIG. 11A and the tier attribute value “quantity” in FIG. 11B are input by the user, and “probability (%)” in FIG. 12 is automatically calculated and accumulated.

It is assumed that the user has then input a graph output instruction “<company identifier> company C <budget identifier> C1” to the terminal apparatus 2. Next, the terminal apparatus 2 accepts the graph output instruction, and transmits it to the business support apparatus 1.

Next, the accepting unit 12 of the business support apparatus 1 receives the graph output instruction “<company identifier> company C<budget identifier> C1”.

Next, the graph configuring unit 132 acquires business information that is paired with the “<company identifier> company C <budget identifier> C1” (FIGS. 11A to 11C and 12).

Next, the graph configuring unit 132 configures a graph that is a diagrammatic representation in which the funnel information, the tier information, and the revenue information are taken as nodes and the nodes are connected by the connection indicated by the edge information shown in FIG. 12, through the processing described with reference to the flowchart in FIG. 5. At this time, the graph configuring unit 132 configures nodes with different outlines (in this case, background colors) depending on the type of nodes such that a node of the funnel information and a node of the tier information and a node of the revenue information can be easily distinguished visually. The graph configuring unit 132 arranges the funnel name and the quantity in the node of the funnel information, arranges the tier name and the quantity in the node of the tier information, and arranges the revenue name and the quantity in the node of the revenue information. The quantities are enclosed in parentheses. The graph configuring unit 132 also arranges a probability at each edge. Through the above-described processing, the graph configuring unit 132 configures a graph showing the business profit structure.

Next, the graph output unit 141 transmits the configured graph to the terminal apparatus 2.

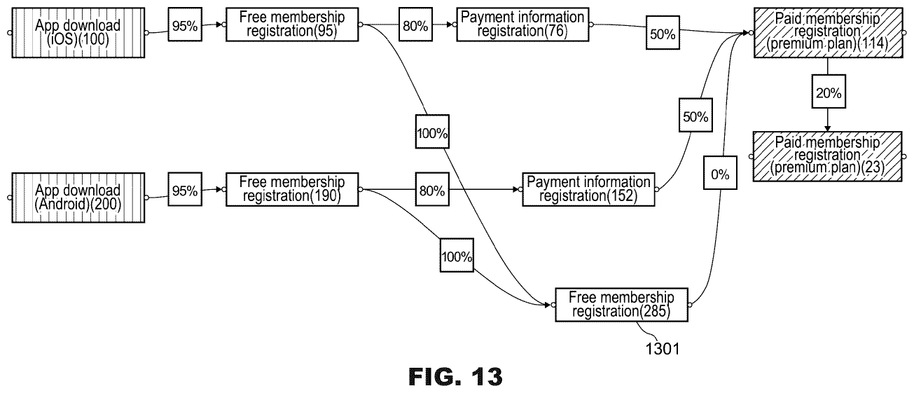

Next, the terminal apparatus 2 receives and outputs the graph. FIG. 13 shows an output example of such a graph. In FIG. 13, the nodes have different background colors depending on the type of nodes. Since the quantities are indicated in the nodes and the probabilities are indicated at the edges, the user can easily see the business profit structure and, as a result, can easily take measures to improve the profitability. In FIG. 13, a node 1301 is a tier, but it can also be a funnel as described above.

Next, it is assumed that the user has input a sales information output instruction “<company identifier> company C <budget identifier> C1” to the terminal apparatus 2. Next, the terminal apparatus 2 accepts the sales information output instruction, and transmits it to the business support apparatus 1.

Next, the accepting unit 12 of the business support apparatus 1 receives the sales information output instruction “<company identifier> company C <budget identifier> C1”.

Next, the sales information acquiring unit 133 acquires sales information using business information that is paired with the “<company identifier> company C <budget identifier> C1” (FIGS. 11A to 11C and 12), through the sales information acquiring processing described with reference to the flowchart in FIG. 9. It is assumed that in this case, the sales information acquiring unit 133 calculates profits for each month from April to September 2024 for two revenues “paid membership registration (premium plan)” and “paid membership registration (ultimate plan)” and “total” of the two revenues, and configures a sales information management table.

Next, the sales information output unit 142 transmits the sales information management table to the terminal apparatus 2.

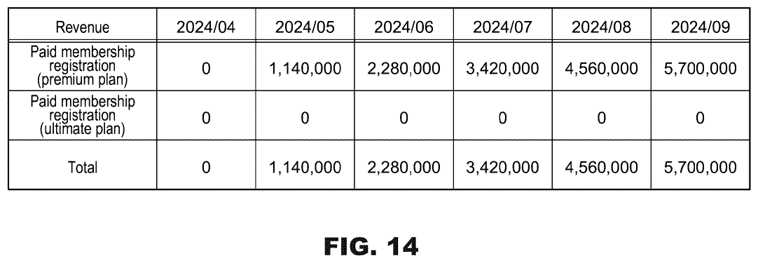

Next, the terminal apparatus 2 receives and outputs the sales information management table. FIG. 14 shows an output example of such a sales information management table. In FIG. 14, the lead time “1 month” contained in the edge information is taken into account, and thus the sales amount in “April 2024” is “0”, and there is a delay of 1 month with respect to generating profits.

This allows the user to ascertain the need to take measures such as borrowing from banks in the “April 2024” stage with the profits “0”.

As described above, according to this embodiment, it is possible to visualize the business profit structure by means of a graph.

Furthermore, according to this embodiment, it is possible to acquire sales information taking a lead time into account.

Moreover, according to this embodiment, the graph of the business profit structure as shown in FIG. 13 and the sales information as shown in FIG. 14 can be viewed together, which makes it easier for the promoter of the business to formulate business strategies. The ease of formulating business strategies means, for example, that it is easier to take measures to improve the profitability.

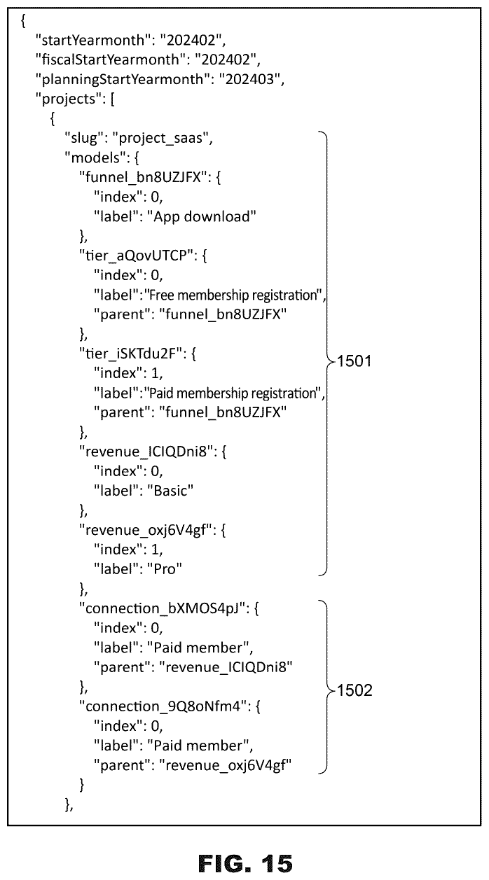

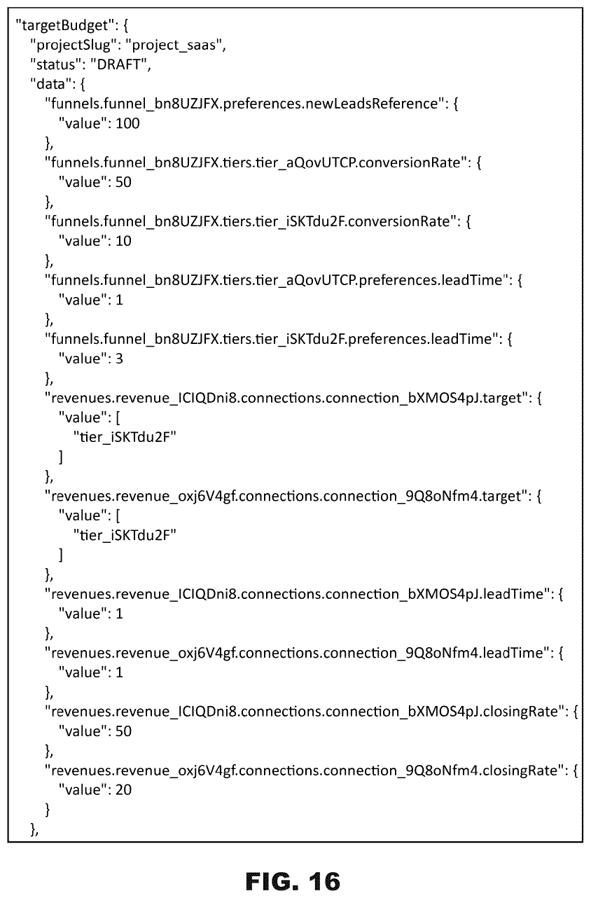

In this embodiment, for example, the accumulating unit 131 accumulates business information with the structure shown in FIGS. 11A to 11C and 12. However, for example, the accumulating unit 131 may accumulate business information with the JSON structure shown in FIGS. 15 and 16. In FIG. 15, 1501 shows a definition example of nodes that are a funnel, a tier, or a revenue. Also, 1502 shows a definition example of edges. FIG. 16 shows a definition example of attribute values of nodes.

“Funnel . . . ”, “tier . . . ”, “revenue . . . ”, and “connection . . . ” in 1501 are all concepts of “model”, and show a definition of “parameter input box”. “Funnel . . . ”, “tier . . . ”, and “revenue . . . ” correspond to the nodes in FIG. 13. “Connection . . . ” corresponds to the edges in FIG. 13.

The processing in this embodiment may be realized by software. The software may be distributed by software downloads or the like. Furthermore, the software may be distributed in a form where the software is stored in a recording medium such as a CD-ROM. The same applies to other embodiments in this specification. The software that realizes the business support apparatus 1 in this embodiment is the following sort of program. Specifically, this program is a program for causing a computer capable of accessing a business management unit in which business information on business corresponding to one budget is stored, the business information containing one or more pieces of funnel information that are each information on a funnel indicating an entry action of a consumer on the business and that each have a funnel name, one or more pieces of tier information that are associated with the one or more pieces of funnel information, that are each information for specifying a tier indicating an action of the consumer in a stage subsequent to a funnel and prior to a sale, and that each have a tier name, and one or more pieces of revenue information that are associated with the one or more pieces of tier information, that are each information for specifying a revenue indicating an action that determines profits, which is performed by the consumer subsequent to a tier, and that each have a revenue name, and further containing first probability information regarding funnel information and tier information that are associated with each other, which is information on a probability that a funnel specified with the funnel information is performed and a tier specified with the tier information is performed, and second probability information regarding tier information and revenue information that are associated with each other, which is information on a probability that a tier specified with the tier information is performed and a revenue specified with the revenue information is performed, to function as: a graph configuring unit that configures a graph with a graph structure in which the one or more pieces of funnel information, the one or more pieces of tier information, and the one or more pieces of revenue information are taken as nodes, association between the funnel information and the tier information is taken as an edge connecting the node of the funnel information and the node of the tier information, and association between the tier information and the revenue information is taken as an edge connecting the node of the tier information and the node of the revenue information, and in which the node of the funnel information, the node of the tier information, and the node of the revenue information are respectively associated with a funnel name, a tier name, and a revenue name, and the edges are associated with the first probability information or the second probability information; and a graph output unit that outputs the graph configured by the graph configuring unit.

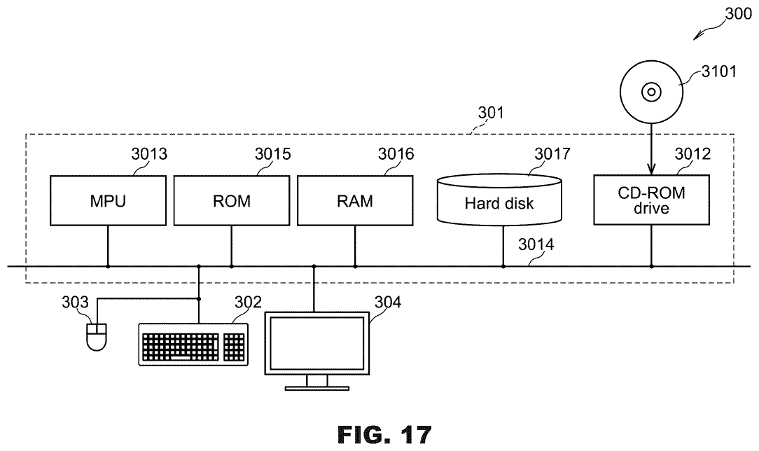

FIG. 17 is a block diagram of a computer system 300 that executes the program described in this specification to realize the business support apparatus 1 and the like in various embodiments described above.

In FIG. 17, the computer system 300 includes a computer 301 including a CD-ROM drive, a keyboard 302, a mouse 303, and a monitor 304. In FIG. 17, the computer 301 includes, in addition to the CD-ROM drive 3012, an MPU 3013, a bus 3014 connected to the CD-ROM drive 3012 and the like, a ROM 3015 in which a program such as a boot up program is stored, a RAM 3016 that is connected to the MPU 3013 and is a memory in which a command of an application program is temporarily stored and a temporary storage area is provided, and a hard disk 3017 in which programs such as an application program and a system program and data are stored. Although not shown, the computer 301 may further include a network card that provides connection to a LAN.

The program for causing the computer system 300 to execute the functions of the business support apparatus 1 and the like in the foregoing embodiments may be stored in a CD-ROM 3101 that is inserted into the CD-ROM drive 3012, and be transmitted to the hard disk 3017. Alternatively, the program may be transmitted via a network (not shown) to the computer 301 and stored in the hard disk 3017. At the time of execution, the program is loaded into the RAM 3016. The program may be loaded from the CD-ROM 3101, or loaded directly from a network.

The program does not necessarily have to include, for example, an operating system (OS) or a third party program to cause the computer 301 to execute the functions of the business support apparatus 1 and the like in the foregoing embodiments. The program may only include a command portion to call an appropriate function (module) in a controlled mode and obtain desired results. The manner in which the computer system 300 operates is well known, and thus a detailed description thereof has been omitted.

It should be noted that, in the program, in a step of transmitting information, a step of receiving information, or the like, processing that is performed by hardware, for example, processing performed by a modem or an interface card in the transmitting step (processing that can be performed only by hardware) is not included.

Furthermore, the computer that executes the program may be constituted by a single computer, or constituted by multiple computers. That is to say, centralized processing may be performed, or distributed processing may be performed.

Furthermore, in the foregoing embodiments, it will be appreciated that at least two communication parts in one apparatus may be physically realized by one medium.

In the foregoing embodiments, each process may be realized as centralized processing using a single apparatus, or may be realized as distributed processing using multiple apparatuses.

The present invention is not limited to the embodiments set forth herein. Various modifications are possible within the scope of the present invention.

As described above, the business support apparatus 1 according to the present invention has an effect of making it possible to visualize the business profit structure, thus rendering this apparatus useful as a server that supports business and the like.

What is claimed is:

1. A business support apparatus comprising:
a business management unit in which business information on business corresponding to one budget is stored, the business information containing:
funnel information on a funnel, which is a starting stage among a plurality of stages related to the business, has a funnel name, and contains a funnel quantity of occurrences of an action corresponding to the funnel information,
tier information associated with the funnel information, the tier information being information for specifying a tier, which is a stage subsequent to the funnel and prior to a sale, has a tier name, and contains a tier quantity of occurrences of an action corresponding to the tier information,
revenue information associated with the tier information, the revenue information being information for specifying a revenue, which is a commercial item or a category of commercial items subsequent to the tier, has a revenue name, and contains a revenue quantity of occurrences of an action corresponding to the revenue information,
first probability information regarding the funnel information and the tier information that are associated with each other, the first probability information being information on a first probability that the funnel specified with the funnel information is performed and the tier specified with the tier information is performed, and
second probability information regarding the tier information and the revenue information that are associated with each other, the second probability information being information on a second probability that the tier specified with the tier information is performed and the revenue specified with the revenue information is performed; and
a processor coupled with a memory storing a program, wherein:
the program, when executed by the processor, causes the processor to perform:
configuring a graph with a graph structure
in which the funnel information, the tier information, and the of revenue information are taken as nodes, association between the funnel information and the tier information is taken as an edge connecting a node of the funnel information and a node of the tier information, and association between the tier information and the revenue information is taken as an edge connecting the node of the tier information and a node of the revenue information,
in which the node of the funnel information, the node of the tier information, and the node of the revenue information are respectively associated with the funnel name and the funnel quantity, the tier name and the tier quantity, and the revenue name and the revenue quantity, wherein each of the edges is associated with a lead time, and
in which edges are associated with the first probability information or the second probability information;
outputting, to a display, the graph configured;
acquiring sales information for each of a plurality of months, using the revenue quantity corresponding to each of revenues and the lead time;
outputting the sales information for each month;
accepting an editing instruction for the graph displayed on the display;
changing the graph in response to the editing instruction;
modifying the business information in the business management unit in response to the change made to the graph; and
acquires new sales information for each of the plurality of months using the business information that has been modified.

2. The business support apparatus according to claim 1, wherein the processor configures the graph such that a node of any type among the funnel information, the tier information and the revenue information has an outline that is different from another node depending on a type of the node.

3. The business support apparatus according to claim 1, wherein:
the revenue information has a unit price, and
the processor configures the graph such that a sales amount obtained by multiplying the unit price and the revenue quantity is associated with each node of the one or more pieces of revenue information.

4. A business support method comprising:
accessing, by a processor, business management unit in which business information on business corresponding to one budget, the business information containing:
funnel information on a funnel, which is a starting stage among a plurality of stages related to the business, has a funnel name, and contains a funnel quantity of occurrences of an action corresponding to the funnel information,
tier information associated with the funnel information, the tier information being information for specifying a tier, which is a stage subsequent to the funnel and prior to a sale, has a tier name, and contains a tier quantity of occurrences of an action corresponding to the tier information,
revenue information associated with the tier information, the revenue information being information for specifying a revenue, which is a commercial item or a category of commercial items subsequent to the tier, has a revenue name, and contains a revenue quantity of occurrences of an action corresponding to the revenue information,
first probability information regarding the funnel information and the tier information that are associated with each other, the first probability information being information on a first probability that the funnel specified with the funnel information is performed and the tier specified with the tier information is performed, and
second probability information regarding the tier information and the revenue information that are associated with each other, the second probability information being information on a second probability that the tier specified with the tier information is performed and the revenue specified with the revenue information is performed;
configuring, by the processor, a graph with a graph structure
in which the funnel information, the tier information, and the of revenue information are taken as nodes, association between the funnel information and the tier information is taken as an edge connecting a node of the funnel information and a node of the tier information, and association between the tier information and the revenue information is taken as an edge connecting the node of the tier information and a node of the revenue information,
in which the node of the funnel information, the node of the tier information, and the node of the revenue information are respectively associated with the funnel name and the funnel quantity, the tier name and the tier quantity, and the revenue name and the revenue quantity, wherein each of the edges is associated with a lead time, and
in which edges are associated with the first probability information or the second probability information;
outputting, to a display, the graph configured;
acquiring sales information for each of a plurality of months, using the revenue quantity corresponding to each of revenues and the lead time;
outputting, by the processor, the sales information for each month;
accepting, by the processor, an editing instruction for the graph displayed on the display;
changing, by the processor, the graph in response to the editing instruction;
modifying, by the processor, the business information in the business management unit in response to the change made to the graph; and
acquires, by the processor, new sales information for each of the plurality of months using the business information that has been modified.

5. The business support method according to claim 4, wherein the graph is configured such that a node of any type among the funnel information, the tier information and the revenue information has an outline that is different from another node depending on a type of the node.

6. The business support method according to claim 4, wherein:
the revenue information has a unit price, and
the graph is configured such that a sales amount obtained by multiplying the unit price and the revenue quantity is associated with each node of the one or more pieces of revenue information.

7. A method for producing a graph of business profits, the method comprising:
accessing a business management unit in which business information on business corresponding to one budget is stored, the business information containing:
one or more pieces of funnel information that are each information on a funnel, which is a starting stage among stages related to the business, and each have a funnel name;
one or more pieces of tier information that are associated with the one or more pieces of funnel information, are each information for specifying a tier, which is a stage subsequent to the funnel and prior to a sale, and each have a tier name;
one or more pieces of revenue information that are associated with the one or more pieces of tier information, are each information for specifying a revenue, which is a commercial item or a category of commercial items subsequent to the tier, and each have a revenue name;
first probability information regarding a piece of funnel information and a piece of tier information that are associated with each other, which is information on a probability that a funnel specified with the piece of funnel information is performed and a tier specified with the piece of tier information is performed; and
second probability information regarding a piece of tier information and a piece of revenue information that are associated with each other, which is information on a probability that a tier specified with the piece of tier information is performed and a revenue specified with the piece of revenue information is performed;
configuring a graph with a graph structure in which the one or more pieces of funnel information, the one or more pieces of tier information, and the one or more pieces of revenue information are taken as nodes, association between one of the one or more pieces of funnel information and one of the one or more pieces of tier information is taken as an edge connecting a node of the one of the one or more pieces of funnel information and a node of the one of the one or more pieces of tier information, and association between one of the one or more pieces of tier information and one of the one or more pieces of the revenue information is taken as an edge connecting a node of the one of the one or more pieces of tier information and a node of the one of the one or more pieces of revenue information, and in which the node of the funnel information, the node of the tier information, and the node of the revenue information are respectively associated with a funnel name, a tier name, and a revenue name, and edges are associated with the first probability information or the second probability information; and
displaying, on a display, the graph configured.
